(19) United States
(12) Patent Application Publication
(10) Pub. No.: US 2006/0230947 A1
(43) Pub. Date: Oct. 19, 2006

(54) Modular baking tray

(76) Inventor: Ernst A. Poppe, Bernex (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/400,429

(22) Filed: Apr. 6, 2006

Related U.S. Application Data
(60) Provisional application No. 60/670,985, filed on Apr. 13, 2005.

(51) Int. Cl. A23P 1/00

(52) U.S. Cl. 99/426

(57) ABSTRACT

A baking tray comprising two or more modules that are individually molded from thermoplastic polymer composition. The modules comprise a top face and a bottom face and being joined by a means for attachment. Each molding optionally comprises openings that allow air circulation between the top face and the bottom face of the module.

### CROSS REFERENCE TO RELATED APPLICATIONS

This application claims the benefit of U.S. Provisional Application No. 60/670,985, filed Apr. 13, 2005.

### FIELD OF THE INVENTION

The present invention relates generally to pans or trays used in the production of baked goods, and specifically to a baking tray for use in high-volume industrial baking applications and fabricated in a modular form from thermoplastic polymers .

### BACKGROUND OF THE INVENTION

Baking pans or trays are commonly used by producers of various baked goods that are supplied to restaurants and grocery stores. Because producers of baked goods often supply large quantities of baked goods to their customers, the trays such goods are baked on are reused many times and are repeatedly subjected to both high thermal and mechanical stresses. Baking pans are large, typically with a long dimension of 0.4 to 2.0 m Stacking pans in this manner creates significant pressure on the bottom pan in a stack, and the weight on the bottom pan may be as much as 200 kilograms. Thus, repeated use and repeated exposure to high temperatures and mechanical stress requires that an industrial baking tray be manufactured from a durable material such as steel or aluminum.

Although manufacturing a baking tray from materials such as steel or aluminum does increase the lifespan of the tray, it would be desirable to be able to fabricate the trays from a thermoplastic polymer, which would provide a lower thermal mass and a more robust, intrinsically non stick surface. However the size of the trays used in the industry precludes the manufacture of trays by traditional molding methods without the danger of warpage of the structure.

Thermoplastic polymers such as crystallized polyethylene terephthalate has been proposed for use as an ovenable frozen food tray/cookware combination. (See U.S. Pat. No. 4,737,389, to Harsing, Jr. et at., issued Apr. 12, 1988).

Thermoplastics, such as styrene, have been proposed for use as a container for cupcakes. Spiraling or concentric annular grooves can be used in the bottom of the container cells so that the bottom of each recess can move relative to the corresponding sidewall. (See U.S. Pat. No. 3,483,908, issued to Donovan on Dec. 16, 1969). A film or sheet of plastic, paper, or the like can be hermetically sealed to cover the openings of the recesses.

An ornamental design for muffin trays is known which includes a recessed land at the top of each muffin cup. (See U.S. Design Pat. No. D 346,528, issued to Crawford et al. on May 3, 1994).

Other patents of interest include U.S. Design Pat. No. 27,936, issued to Schmidt on Dec. 7, 1987; U.S. Pat. No. 936,232 issued to Musser on Oct. 12, 1909; U.S. Pat. No. 1,719,842 issued to Jackson on Jul. 9, 1929; U.S. Pat. No. 3,099,377 issued to Metzler et al. on Jul. 30, 1963; U.S. Pat. No. 4,296,682 issued to Thompson on Oct. 27, 1981; and U.S. Pat. No. 5,213,227, issued to Koyama et at. on May 25, 1993.

### SUMMARY OF THE INVENTION

A general object of the present invention is to overcome problems associated with prior art baking trays and provide the baker with a low thermal mass article that can be disassembled and reassembled with ease and into any required shape or configuration consistent with the design of the modules that the baking tray comprises.

A more specific object of the present invention is to provide a baking tray fashioned from a thermoplastic material configured to retain shape during baking processes, to provide uniform baking.

These objects are satisfied by a baking tray fashioned from modules that have been individually molded from a polymer such as in one embodiment a liquid crystal polymer having a plurality of attachment points that allow modules to be fixed on a metal or wire frame.

### DETAILED DESCRIPTION OF THE INVENTION

The baking tray of the invention comprises two or more modules that are individually molded from a thermoplastic material. The modules comprise a top face and a bottom face and are joined by a means for attachment. Each molding optionally comprising openings that allow air circulation between the top face and the bottom face of the module.

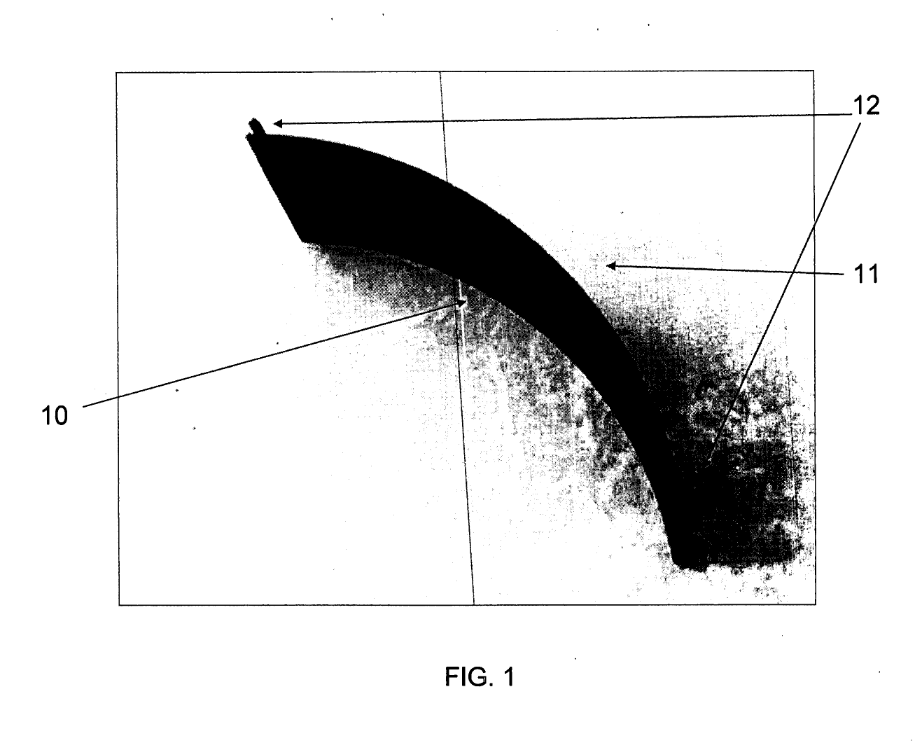

The means of attachment can be any method that secures one module to the metal or wire frame. For example, turning to FIG. 1, a single module comprises a concave surface (10) and a convex surface (11) such that when the modules are secured together, the tray has a shape into which, for example, bread dough can be placed in preparation for baking.

The module also comprises hooks or tabs (12) that allow the module to be secured to or rested upon a frame. The module can also optionally have holes -joining the concave and convex surfaces that allow for air circulation between the two surfaces.

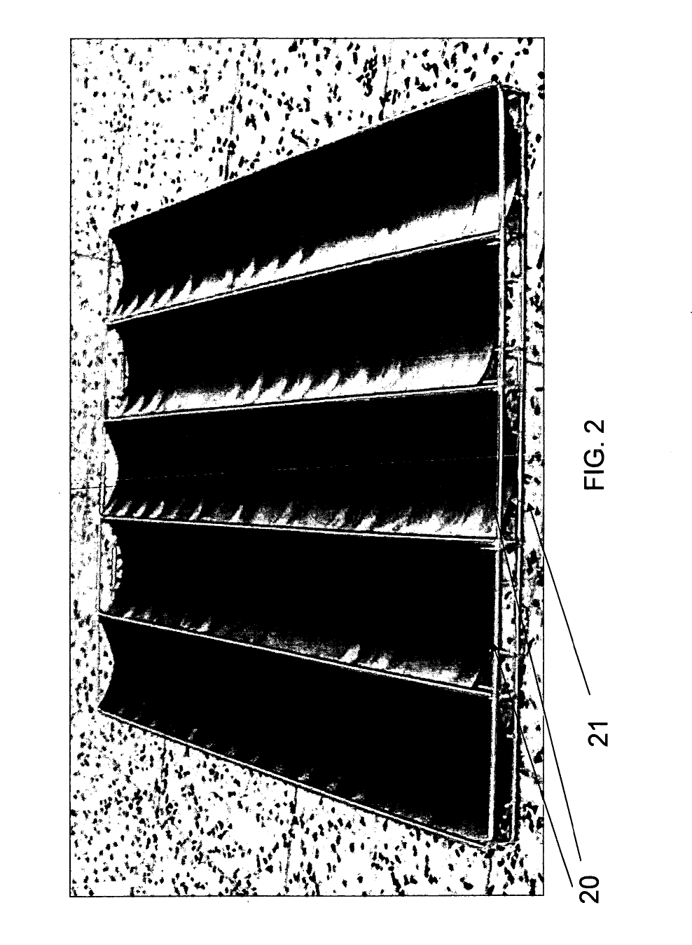

In FIG. 2 is shown a construction of the baking tray in which the modules (20) are assembled on a wire frame (21).

There is no particular limitation on the thermoplastic material that the tray comprises, although in a preferred embodiment the thermoplastic material is a thermoplastic polymer. More preferably the baking comprises a thermoplastic polymer that has a melting point of greater than 280° C., and even more preferably the baking tray comprises a thermoplastic polymer that has a melting point of greater than 300° C.

Additionally, the baking tray may comprise a thermoplastic material that comprises a thermoplastic polymer plus a filler selected from the group consisting of glass, calcium carbonate, mica, talc and any combination thereof.

The baking tray may also comprise a thermoplastic polymer composition that comprises a liquid crystalline polymer, an example of which is Zenite® a product of the Du Pont Company (Wilmington, Del.).

The examples shown in the figures and the description given herein are presented for illustrative purposes only, and are not intended to limit the scope of the present invention in any manner. One skilled in the art will be able to devise, for example, other shapes and designs of modules and means of attachment that do not deviate from the invention presented herein.

I claim:

1.) A baking tray comprising two or more modules that are individually molded from thermoplastic material, said modules comprising a concave top face and a convex bottom face, and being assembled onto a wire frame, and each molding optionally comprising openings that allow air circulation between the top face and the bottom face of the module.

2.) The baking tray of claim 1 in which the thermoplastic material comprises a thermoplastic polymer that has a melting point of greater than 280° C.

3.) The baking tray of claim 1 in which the thermoplastic material comprises a thermoplastic polymer that has a melting point of greater than 300° C.

4.) The baking tray of claim 1 in which the thermoplastic material comprises a filler selected from the group consisting of glass, calcium carbonate, mica, talc and any combination thereof.

5.) The baking tray of claim 1 in which the thermoplastic material comprises a liquid crystalline polymer.
